(19) United States
(12) Patent Application Publication
(10) Pub. No.: US 2004/0245940 A1
(43) Pub. Date: Dec. 9, 2004

(54) High frequency induction circuit used for the advertisement lamp box

(76) Inventor: Black Smith, Taipei City (TW)

Correspondence Address: RABIN & BERDO, P.C., Suite 500, 1101 14th Street, N.W., Washington, DC, 20005, US

(21) Appl. No.: 10/452,719

(22) Filed: Jun. 3, 2003

(51) Int. Cl. H05B 41/16

(52) U.S. Cl. 315/247

(57) ABSTRACT

The present invention relates to a high frequency induction circuit of the advertisement lamp box, comprising a transformer connected to the local power supply; a rectifier circuit connected to the transformer; a high frequency generation circuit powered by the rectifier circuit for generating high frequency signals; and a plurality of induction plates used to receive the high frequency signals generated by the high frequency generating circuit, and a plurality of light emitters provided on the induction plate for receiving the induction signals and emitting the lights. As such, it can fulfill the users' requirements and rapidly changing the arrangement positions of a plurality of the light emitters to achieve the effects of cost saving and rapidly changing the advertisement panel displays.

### BACKGROUND OF THE INVENTION

1. Field of the Invention

The present invention relates to the high frequency induction circuit used in the advertisement lamp box, particularly relates to a high frequency induction circuit which can fulfill the requirements of the users so as to rapidly changing the arrangement positions of a plurality of light emitters to achieve the effect of cost saving and rapidly changing the advertisement panels displays.

2. Description of the Prior Art

In the commercial business today, people usually spend huge amount of money on television advertisements so as to achieve great fame and popularity for their new products in very short period of time, and all these expenses are evenly distributed to the costs of the corresponding products. However, it is not only unfair for the initial period consumers to bear the costs, but also not all the manufacturers can bear such huge amount of advertisement expenses. However, plane surface advertisement is rather another means of saving the advertisement expenses, while at the same time achieving the purpose of information distribution. Besides, it can timely reflect the costs of the products. Therefore, many indoor and outdoor public localities are provided with lots of advertisement lamp boxes. For the purpose of achieving the effect of advertisement around the clock, the construction of the traditional advertisement lamp box is roughly as follows: the inside of the lamp box is provided with the light source and the advertisement illumination plates, and the outside of the lamp box is provided with the edge frames and the connection blocks. The advertisement illumination plates are fixed to the inside of the lamp through edge frames and the connection blocks, then light is projected from the light source in the lamp box onto the advertisement illumination plates, so as to make the patterns on the advertisement illumination plates characterize the 3-dimensional, dynamic, bright and colorful visual effects, and to attract the attention of the passer-bys. And the method of replacing the advertisement illumination plates is no other than first removing the back planes of the lamp box or removing the four edge frames and the connection blocks, and then replacing the advertisement illumination plates. However, this method is too tedious and cumbersome, especially when it needs to replace large quantities of advertisement illumination plates, the time and manpower required are too much and its efficiency is not too good, and this is not suitable for the rapidly developing society of business and industry today.

### BRIEF SUMMARY OF THE INVENTION

In view of the problems the conventional advertisement lamp box may create, the inventor of the invention feels it has not been perfected yet, therefore basing on his many years experience accumulated in this industry, and dedicating his efforts to the related research to overcome these problems, so as to develop a kind of high frequency induction circuit used in the advertisement lamp box which can respond to the requirements of the users and rapidly changing the arrangement positions of a plurality of light emitters, to achieve cost saving and rapidly changing the advertisement panel displays. Therefore, the purpose of the present invention is to design a high frequency induction circuit used in the advertisement lamp box which can fulfill the users' requirements and rapidly changing the arrangement positions of a plurality of light emitters to achieve the effect of cost saving and rapidly changing the advertisement panel displays.

In order to obtain the above mentioned purpose, the present invention is realized as follows: to provide a high frequency induction circuit used for advertisement lamp box, comprising a transformer connected to the local power supply, a rectifier circuit connected to the transformer, a high frequency generation circuit powered by the rectifier circuit and generates high frequency signals; and a plurality of induction plates which can receive the high frequency signals generated by the high frequency generation circuit; and a plurality of light emitters provided on the induction plates which can receive the induction signals and emit light and form different shaped patterns, e.g. numeric, English characters etc. As such, it can fulfill the users' requirements, rapidly changing the arrangement positions of a plurality of light emitters so as to achieve the effect of cost-saving and rapidly changing the advertisement panel displays.

### BRIEF DESCRIPTION OF THE DRAWINGS

FIG. 1 is the circuit block diagram of the present invention;

FIG. 2 is the circuit diagram of the present invention;

FIG. 3 is the application state reference FIG. 1 of the present invention;

FIG. 4 is the application state reference FIG. 2 of the present invention; and

FIG. 5 is the drawing of the preferred embodiment of the present invention.

### DETAILED DESCRIPTION OF THE PREFERRED EMBODIMENTS

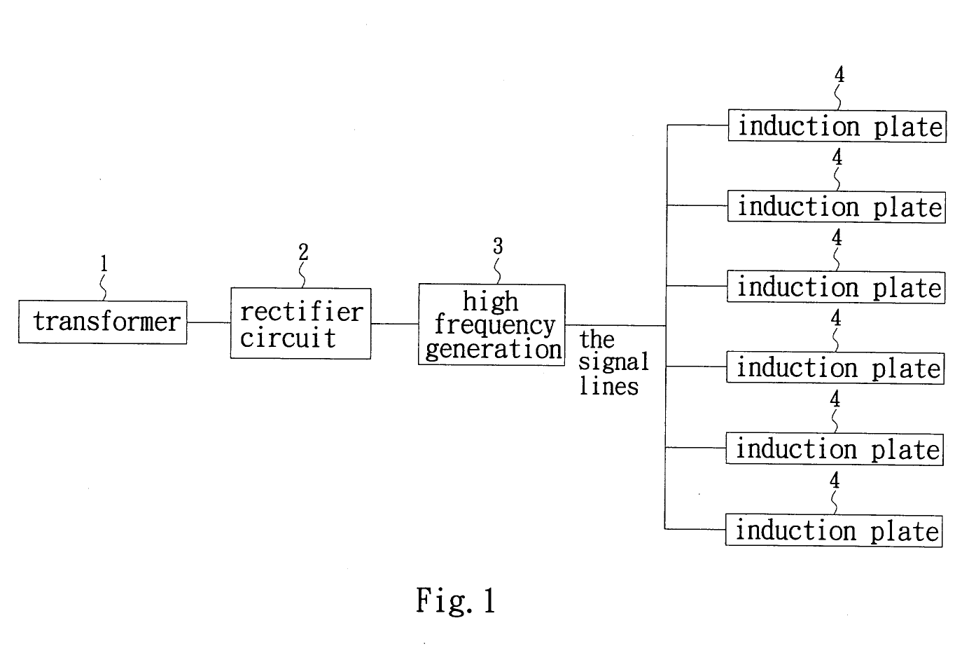

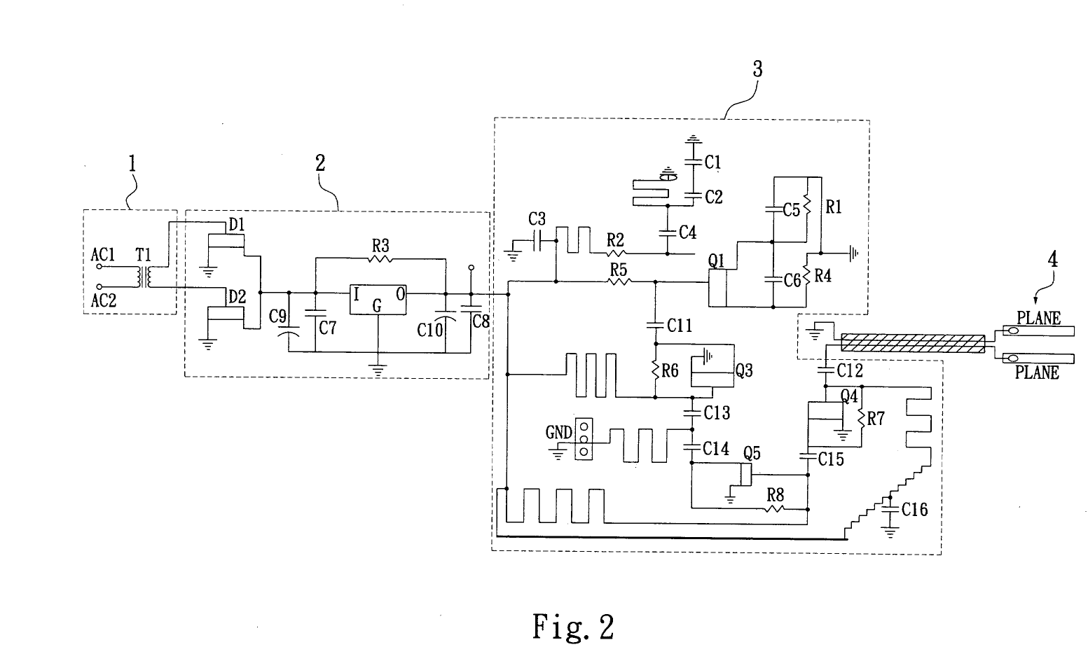

Please refer to FIGS. 1 and 2 depicting the circuit block diagram and the circuit diagram of the present invention respectively. As shown in the drawings, the said high frequency induction circuit used in the advertisement lamp box includes: a transformer 1, connected to the alternating current (AC) of the ordinary local power supply, and converting and reducing its voltage to 9V direct current (DC); a rectifier circuit 2, connected to the output of the transformer 1, and rectifying the 9V direct current to a more stable direct current; a high frequency generation circuit 3, receiving the direct current output from the rectifier circuit 2, and generating high frequency signals by using the oscillation of the capacitors and the inductors; a plurality of induction plates 4, connected to the high frequency generation circuit 3 through the signal lines, which enable the high frequency signals to be output to each induction plate 4.

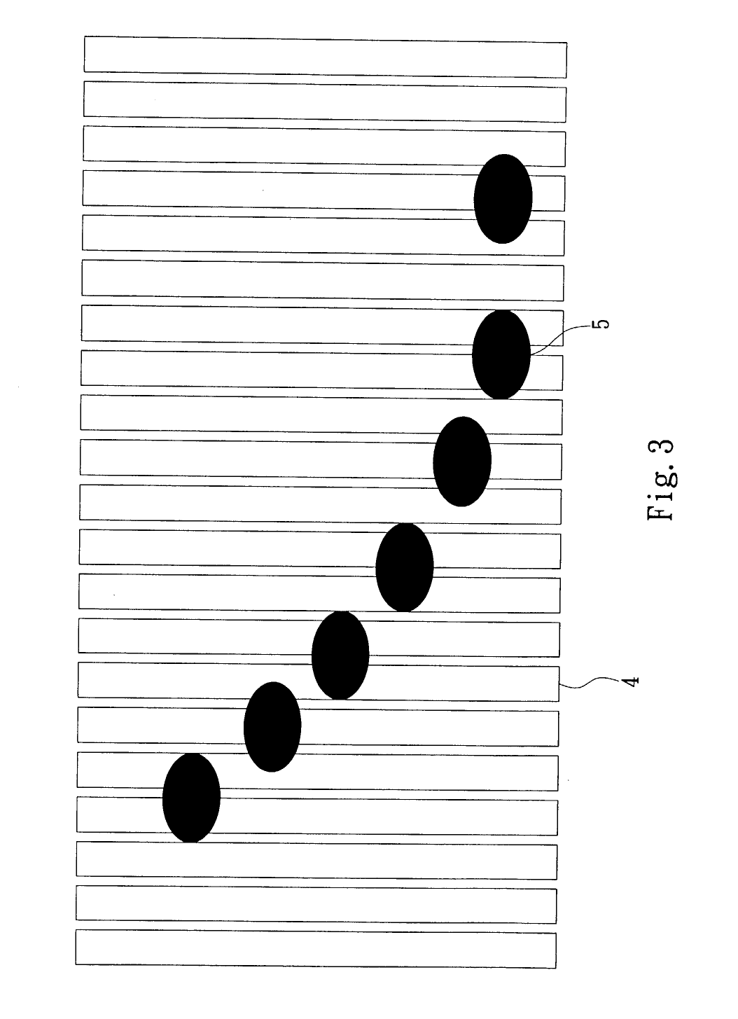

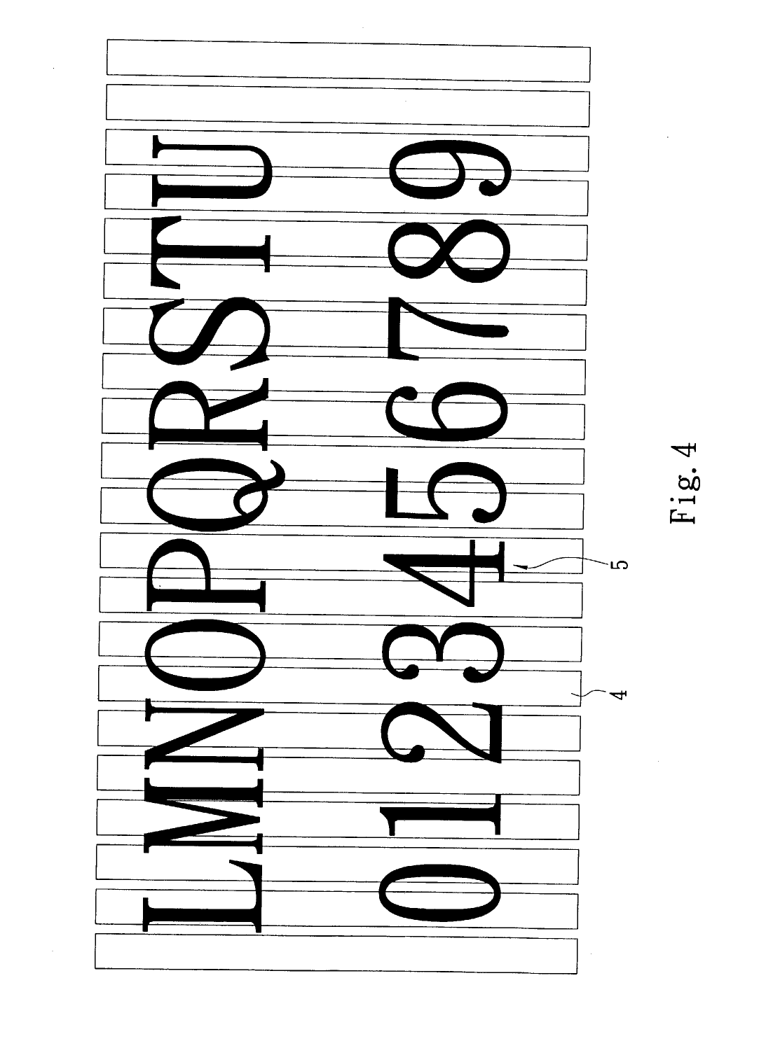

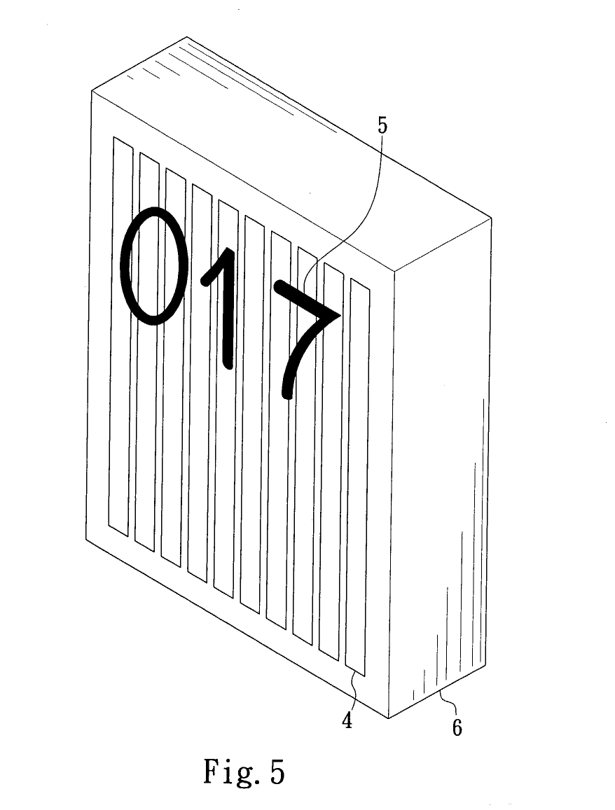

The circuit design of the present invention can be applied in the advertisement lamp box. Please refer to FIGS. 3, 4, 5, which represent the application state reference drawings 1 and 2, and the preferred embodiment drawing respectively. As shown in the drawings: when the present invention is applied to the advertisement lamp box 6 (as shown in FIG. 5), a plurality of induction plates 4 are provided on the displaying surfaces of the advertisement lamp box 6, and each induction plate 4 is connected to the output of the high frequency generation circuit 3. As such, a plurality of light emitters 5 can display the patterns of graphs, numbers, English characters, and other characters. Since high frequency signals do not differentiate into the differences of positive and negative polarities, therefore, even if the said light emitter 5 is disposed across between two induction plates 4 at the same time, the short circuit condition would not occur. Besides, the said light emitter can convert the high frequency signals received and inducted into small voltages and small currents, so as to make the LED or PLED in the light emitter 5 emit light. As such, it can fulfill the requirement of the user, rapidly changing the arrangement positions of a plurality of light emitters 5, so as to achieve the effect of cost-saving and rapidly changing the advertisement panel displays.

What I claim as my invention is:

1. A high frequency induction circuit used for the advertisement lamp box, characterized in that comprising:
a transformer connected to the local power supply;
a rectifier circuit connected to the transformer;
a high frequency generation circuit powered by the rectifier circuit for generating high frequency signals; a plurality of induction plates receiving the high frequency signals of the high frequency generation circuit; and a plurality of light emitters provided on the induction plate for receiving the induction signals and emitting light.

2. The high frequency induction circuit used for the advertisement lamp as claimed in claim 1, wherein the high frequency generation circuit generates the high frequency signals through the resonance of the capacitors and inductors.

3. The high frequency induction circuit used for the advertisement lamp as claimed in claim 1, wherein the LEDs are contained in the light emitter.

4. The high frequency induction circuit used for the advertisement lamp as claimed in claim 1, wherein the PLEDs are contained in the light emitter.
